(19) United States
(12) Patent Application Publication
(10) Pub. No.: US 2010/0316073 A1
(43) Pub. Date: Dec. 16, 2010

(54) OPTICALLY PUMPED SOLID-STATE LASER WITH CO-DOPED GAIN MEDIUM

(75) Inventors: Ulrich Weichmann, Aachen (DE); Peter J.W. Schmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/446,271

(22) PCT Filed: Oct. 15, 2007
(86) PCT No.: PCT/IB2007/054188

§ 371 Date: Apr. 20, 2009

(30) Foreign Application Priority Data
Oct. 24, 2006 (EP) 061228250.0

(51) Int. Cl. H01S 3/16; H01S 3/094; H01S 3/0941

(52) U.S. Cl. 372/39

(57) ABSTRACT

The present invention relates to a solid-state laser comprising a gain medium (6) of a solid-state host material which is co-doped with Ce³⁺-ions and ions of a further rare-earth material. The host material is selected such that a lower edge of the 5d band of the Ce³⁺-ions is energetically higher than an upper lasing state of the ions of the further rare-earth material. This laser can be optically pumped by GaN laser diodes (4) in the wavelength region between 400 and 450 nm and emits laser radiation in the visible wavelength range. With this laser, in particular, a GaN diode laser pumped solid-state laser emitting in the green wavelength region can be realized.

### TECHNICAL FIELD

The present invention relates to a solid-state laser comprising a gain medium of a solid-state host material, which is doped with rare-earth ions.

Lasers are good candidates to replace nowadays UHP-lamps (UHP: Ultra High Performance) as the light source for projection systems. While red and blue laser diodes are available, the lack of integrated laser sources in the green wavelength region has until now hindered the widespread use of lasers for display or illumination applications.

### BACKGROUND OF THE INVENTION

Nowadays used laser sources for the green wavelength region rely on frequency conversion either by upconversion or by second harmonic generation (SHG) of an infrared laser source.

An alternative to upconversion from the infrared wavelength region is the frequency conversion of blue laser sources like in the case of the well-known dye lasers. With the recent development of GaN-based laser diodes for the blue-violet region this scheme becomes attractive for all-solid-state devices.

U.S. Pat. No. 6,816,532 B2 discloses a laser diode exited laser apparatus in which the gain medium is doped with rare-earth ions, in particular with Ho³⁺-, Sm³⁺-, Eu³⁺-, Dy³⁺-, Er³⁺- and T³⁺-ions. The solid gain medium is pumped by a GaN based laser diode. Both the excitation and the laser emission of the disclosed laser involve transitions between 4f states of the rare-earth ion. Since the absorption at these transitions is relatively weak, the efficiency of the devices is limited and long interaction lengths like for example in fiber lasers are required. For populating the upper laser level ⁵D₄ of the Tb³⁺-ion with a GaN laser diode as the pump source, either excitation at 488 nm or at 380 nm towards the ⁵D₃ level with successive relation towards the ⁵D₄ level is required. Efficient GaN laser diodes at both pump wavelengths 488 nm and 380 nm are not available yet.

### SUMMARY OF THE INVENTION

It is an object of the present invention to provide a solid-state laser emitting in the visible wavelength region, which can be optically pumped efficiently by GaN laser diodes.

The object is achieved with the solid-state laser according to claim 1. Advantageous embodiments are subject matter of the sub claims or are described in the subsequent description including the embodiments for carrying out of the invention.

The proposed solid-state laser comprises a gain medium of a solid-state host material, which is co-doped with the Ce³⁺-ions and with ions of a further rare-earth material. The host material is selected such that a lower edge of the 5d band of the Ce³⁺-ion is energetically higher than an upper lasing state of the ions of the further rare-earth material.

With such a gain medium, the proposed all solid-state laser can be pumped efficiently with GaN laser diodes in the wavelength range of for example between 400 and 450 nm. The gain medium absorbs the radiation of the pump laser via the 4f-5d transitions in the Ce³⁺-ion. From the 5d band of the Ce³⁺-ion the energy is transferred to the upper lasing state of the further rare-earth ion which then emits the desired laser radiation through a transition between the upper lasing state and a lower lasing state. The emitted laser wavelength is influenced by the selection of the further rare-earth ions and may further be influenced by the spectral characteristics of the resonator mirrors of the solid-state laser. The proper selection of the host material is very important, since this host material influences the energy levels of both rare-earth ions.

Advantageous combinations of the Ce³⁺-ions with further trivalent rare-earth ions are combinations of Ce³⁺-ions with Pr³⁺, Sm³⁺, Eu³⁺, Dy³⁺ and Tm³⁺ to design lasers emitting with different wavelengths in the visible wavelength range.

In a preferred embodiment the proposed solid-state laser comprises a gain medium of a solid-state host material, which is co-doped with Ce³⁺-ions and Tb³⁺-ions. In this case, the laser pumping scheme involves 4f-5d-transitions in Ce³⁺, energy transfer from the Ce³⁺ 5d band to the ⁵D₄-state of Tb³⁺, from which laser emission takes place. This scheme is very attractive since it combines the high absorption of 4f-5d-transitions with the known laser properties of rare-earth 4f-4f lasers. Highly integrated, efficient laser devices are therefore possible. The Tb³⁺ion is very attractive to provide an optically pumped solid-state laser in the green wavelength range, since it has a well isolated ⁵D₄ state with a long lifetime in many hosts. From this ⁵D₄-level green emission around 543 nm is very pronounced.

The dopant concentration c_{Ce} for the Ce³⁺-ions is preferably in the range of 0.01% wt to 5% wt. The concentration of the Tb³⁺-ions c_{Tb} is preferably selected depending on the concentration c_{Ce} of the Ce³⁺-ions according to c_{Tb}=k*c_{Ce}, with k varying between 0.5 and 50.

Since the energetic position of the 5f bands in the Ce³⁺-ions as well as of the lasing states in the further rare-earth ions depend on the host material, the appropriate selection of this host material is important in order to achieve the desired laser action. Very advantageous laser operation has been observed when using host materials with an energy gap of at least 6 eV. The host materials also have to ensure the energy transfer between the 5d-band of the Ce³⁺-ions and, for example, the ⁵D₄ state of the Tb³⁺ ions. Preferred host materials for the proposed solid-state laser are Y₃₋ₓLuₓAl_{5-y}Ga_{y}O₁₂ (x=1, 2, 3; y=1, 2, 3, 4, 5), Y₃₋ₓCaₓAl₅₋ₓSiₓO₁₂, Y₃₋ₓAl₅₋ₓScₓO₁₂, M₂O₃ (with M=Sc, Y, Lu, Gd, La), CaYAlO₄ and M₂SiO₅ (with M=Y, Lu, Gd or combinations of these).

In the proposed solid-state laser the Ce³⁺-ions act as a sensitizer and provide a good absorption of the pump radiation via the 4f-5d transitions, whereas the further rare-earth ions act as the laser active ions. Although it is known in the art that solid-state host materials doped with Ce³⁺-ions are not suited for laser action due to very strong excited state absorption, it was surprisingly found by the inventors of the present invention, that by co-doping the Ce³⁺-ions with further trivalent rare-earth ions and by selecting an appropriate host material, laser action can be achieved in an efficient manner. Furthermore, by combination of Ce³⁺- with Tb³⁺-ions an all-solid-state laser is realized which can be efficiently pumped by GaN based laser diodes to emit in the green wavelength range. Such all-solid-state laser systems including the pump laser can be manufactured in a highly integrated manner and are in particular suited as light sources for projection systems in display or illumination applications.

The optical design of the all-solid-state laser can be chosen as known in the art. Such a laser can be set up for example in the form of an end pumped rod, similar to other diode pumped solid-state lasers known in the art. The proposed laser can also be designed in the form of a planar waveguide laser, in which the co-doped material is brought to the form of a planar waveguide that is adapted in its geometry to the emission profile of the laser diode. In this case, the laser diode and the co-doped conversion medium are preferably placed on a shared cooling structure, which allows for a highly integrated device. The high absorption of the Ce³⁺-ions allows also for transversal pump geometries, in which the laser radiation emerges in a direction perpendicular to the direction of the pump radiation.

These and other aspects of the invention will be apparent from and elucidated with reference to the embodiments described herein after.

### BRIEF DESCRIPTION OF THE DRAWINGS

The proposed solid-state laser and laser system will be described in the following by way of examples in connection with the accompanying figures without limiting the scope of protection as defined by the claims. The figures show:

FIG. 1 an excitation scheme of a preferred embodiment of the proposed laser;

FIG. 2 an example for an end pumped geometry of the proposed laser; and

FIG. 3 an example of a transversally pumped geometry of the proposed laser.

### EMBODIMENTS FOR CARRYING OUT THE INVENTION

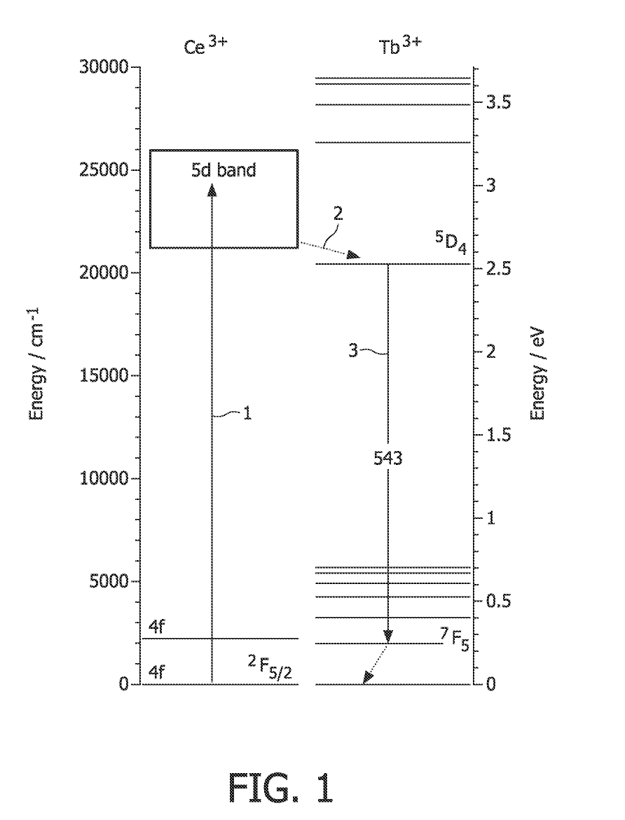

In the following embodiments the gain medium of the proposed laser is co-doped with Ce³⁺- and Tb³⁺-ions. The Ce—Tb-laser is pumped with a GaN based laser diode. FIG. 1 shows the pumping and lasing scheme of such a solid-state laser. The blue pump radiation 1 of the GaN based laser diode is absorbed via the 4f-5d transition of the Ce³⁺-ions. After excitation with the pump radiation 1 energy transfer 2 takes place between the 5d band of the Ce³⁺-ions and the upper lasing state (⁵D₄ state) of the Tb³⁺-ions as is indicated in the figure. From this ⁵D₄ state of the Tb³⁺-ions laser emission 3 around 543 nm starts by transition to a lower state of the Tb³⁺-ions. The laser emission 3 is very pronounced in this laser scheme.

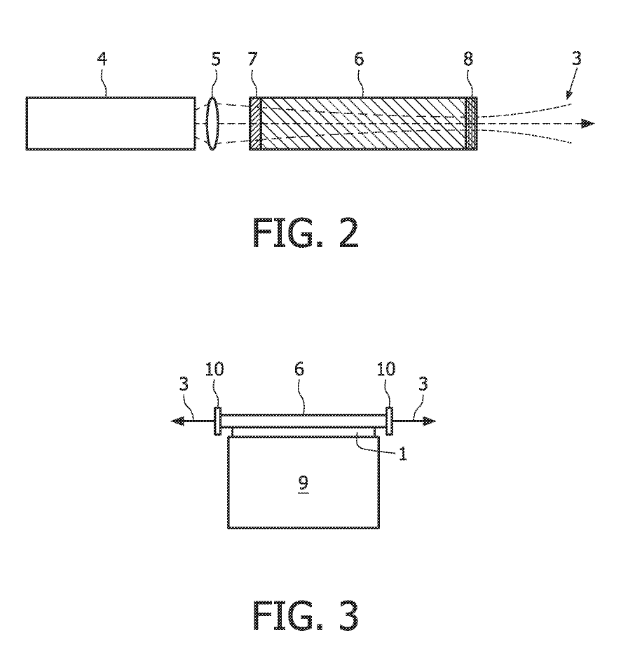

FIG. 2 shows an example for an end pumped geometry of the proposed Ce—Tb-laser. The pump radiation emitted by a GaN laser diode 4 is focused by appropriate optics 5 through the first resonator end mirror 7 of the solid-state laser into the Ce³⁺—Tb³⁺ co-doped gain material 6. The first resonator end mirror 7 used for end pumping is highly reflective for radiation in the green wavelength region and antireflective for the pump radiation wavelength. The second resonator end mirror 8 on the other hand is highly reflective for the wavelength of the pump radiation and sufficiently reflective for the green wavelength emitted by the gain material 6 in order to achieve lasing action. On the other hand this second resonator end mirror 8 allows the outcoupling of a portion of the laser emission 3 in the green wavelength region.

FIG. 3 shows another example for the design of the proposed solid-state laser. In this example, a transversally pumped geometry is used for the Ce—Tb-laser. The gain medium 6 of the Ce—Tb-laser in this case has two resonator end mirrors 10 which reflect a sufficiently high portion of the generated green radiation to maintain laser action. Both resonator end mirrors 10 also serve as outcoupling mirrors for the laser radiation 3. The gain medium 6 is transversally pumped by a GaN diode laser module 9 composed of several GaN laser diodes side by side in order to achieve emission of the pump radiation 1 over the whole length of the gain medium 6 as indicated in FIG. 3.

While the invention has been illustrated and described in detail in the drawings and foregoing description, such illustration and description are to be considered illustrative or exemplary and not restrictive; the invention is not limited to the disclosed embodiments. The different embodiments described above and in the claims can also be combined.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of these claims.

### LIST OF REFERENCE SIGNS

1 pump radiation
2 energy transfer
3 laser radiation
4 GaN laser diode
5 optics
6 Ce³⁺—Tb³⁺ co-doped gain material
7 first resonator end mirror
8 second resonator end mirror
9 GaN diode laser module
10 resonator mirrors

1. Solid-state laser comprising a gain medium (6) of a solid-state host material, which is co-doped with Ce3+-ions and ions of a further rare earth material, the host material being selected such that a lower edge of a 5d band of the Ce3+-ions is energetically higher than an upper lasing state of the ions of the further rare earth material.

2. Solid-state laser according to claim 1, wherein the ions of the further rare earth material are Tb3+-ions.

3. Solid-state laser according to claim 2, wherein the host material is selected such that the lower edge of the 5d band of the Ce3+-ions is energetically higher than the 5D4 state of the Tb3+-ions and that an energy gap of the host material is >6 eV.

4. Solid-state laser according to claim 1 or 2, wherein the host material is selected from the group consisting of: Y3-xLuxAl5-yGayO12 (x=1, 2, 3; y=1, 2, 3, 4, 5), Y3-xCaxAl5-xSixO12, Y3-xAl5-xScxO12, M2O3 (with M=Sc, Y, Lu, Gd, La), CaYAlO4 and M2SiO5 (with M=Y, Lu, Gd or combinations of these).

5. Solid-state laser according to claim 4, wherein the host material has a dopant concentration of the Ce3+-ions in the range of 0.01% wt to 5% wt and a dopant concentration of the Tb3+-ions, which is between 0.5 and 50 times the dopant concentration of the Ce3+-ions.

6. Solid-state laser according to claim 1, wherein the ions of the further rare earth material are selected from Pr3+-, Sm3+-, Eu3+-, Dy3+- and Tm3+-ions.

7. Solid-state laser system comprising a solid-state laser according to claim 1, and at least one GaN laser diode (4) arranged to optically pump the gain medium (6) of the solid-state laser.

8. Solid-state laser system comprising a solid-state laser according to claim 4, and at least one GaN laser diode (4) arranged to optically pump the gain medium (6) of the solid-state laser.
